(19) United States
(12) Patent Application Publication
(10) Pub. No.: US 2019/0200598 A1
(43) Pub. Date: Jul. 4, 2019

(54) SPRAY HEAD

(71) Applicant: SHIN TAI SPURT WATER OF THE GARDEN TOOLS CO., LTD., LU-KANG TOWN (TW)

(72) Inventor: Chin-Yuan Chen, LU-KANG TOWN (TW)

(21) Appl. No.: 15/862,609

(22) Filed: Jan. 4, 2018

(51) Int. Cl. A01M 7/00; B05B 13/02; B05B 15/68; B05B 15/63; B05B 15/65; B05B 9/01

(52) U.S. Cl. CPC A01M 7/0046; B05B 13/0278; B05B 9/01; B05B 15/63; B05B 15/65; B05B 15/68

(57) ABSTRACT

The garden spray structure has a main body, a water guiding member and a spray head. The main body has a handle portion and a chamber portion which are connected with each other, the handle portion is configured for connecting with a water source and hand-held purpose, and water is fed to from the handle portion to the chamber portion while the handle portion is held. Furthermore, an engagement opening provided in front of the chamber portion is configured for engaging with the water guiding member, after a supply tube provided with the water guiding member is inserted the chamber portion. Also, the water guiding member is provided with a central shaft extending from the front opening, and the central shaft passes through the spray head and the central shaft is locked so that the spray head is mounted at the front of the water guiding member.

### BACKGROUND OF THE INVENTION

### 1. Field of the Invention

The present invention relates to a garden spray.

### 2. Description of the Related Art

Typical garden spray 50, as shown in FIG. 6 and FIG. 7, has an enlarged output opening 511 in front of a main body 51, and a water guiding member 52 provided with a water outlet 521 offset to one side is connected to the output opening 511. Furthermore, the water outlet 521 is connected with a water channel 512 in the main body 51, so water flow can be conducted. The water guiding member 52 is provided with a central shaft 522 at the center, and the central shaft 522 is configured for locked with a spray head 53 at the front of the water guiding member 52. The peripheral wall 531 of the spray head 53 allows the user to rotate to select an appropriate water spray shape for ejection.

However, there are still some problems in the typical garden spray as follows: the water guiding member 52 is only connected to the output opening 511 of the main body 51 only, and the water flow channel 512 is not connected to the main body 51. The small contact area of the sleeve easily leads to water leakage at the junction of the main body 51 and the water guiding member 52 in the garden spray 50.

Therefore, it is desirable to provide a garden spray to mitigate and/or obviate the aforementioned problems.

### SUMMARY OF INVENTION

An objective of present invention is to provide garden spray which is capable of improving the above-mention problems.

In order to achieve the above mentioned objective, A Garden spray comprises: a main body, a water guiding member and a spray head. The main body has a handle portion and a chamber portion which are connected with each other, and the handle portion is configured for connecting with a water source and hand-holding such that water is fed to from the handle portion to the chamber portion while the handle portion is held. Furthermore, an engagement opening provided in front of the chamber portion is configured for engaging with the water guiding member, after a supply tube provided with the water guiding member is inserted the chamber portion. The water guiding member is a housing having a front opening, and the supply tube protrudes from a closed surface of a rear portion of the housing. A front end of the supply tube is defined as an output opening passes through the housing and the supply tube is inserted into the chamber portion through the engagement opening so that the water guiding member can be extensively connected to the main body due to the combination between the chamber portion and the supply tube. Moreover, a stopping member is sandwiched between the supply tube and the end portion of the chamber portion. Also, the water guiding member is provided with a central shaft extending from the front opening, and the central shaft passes through the spray head and the central shaft is locked so that the spray head is mounted at the front of the water guiding member. An outer circumference of the supply tube is provided with at least a sealing washer, and the output opening is provided with a sealing ring.

Other objects, advantages, and novel features of invention will become more apparent from the following detailed description when taken in conjunction with the accompanying drawings.

### BRIEF DESCRIPTION OF DRAWINGS

FIG. 1 is a perspective drawing of a preferred embodiment according to the present invention.

FIG. 2 is an exploded view of the preferred embodiment according to the present invention.

FIG. 3 is an exploded cross-sectional view of the preferred embodiment according to the present invention.

FIG. 4 is a perspective view of the water guiding member from another view angle according to the present invention.

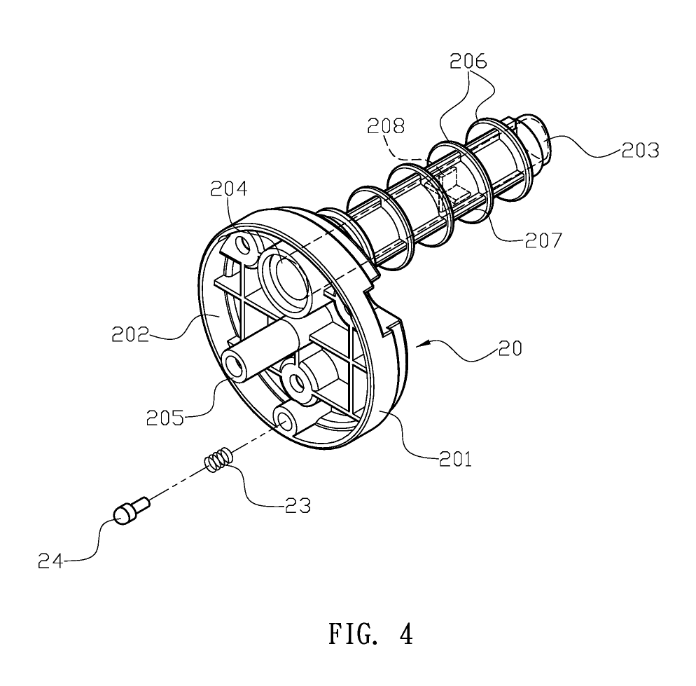

FIG. 5 is a schematic drawing of water flow according to the present invention.

FIG. 6 is a drawing of a conventional structure.

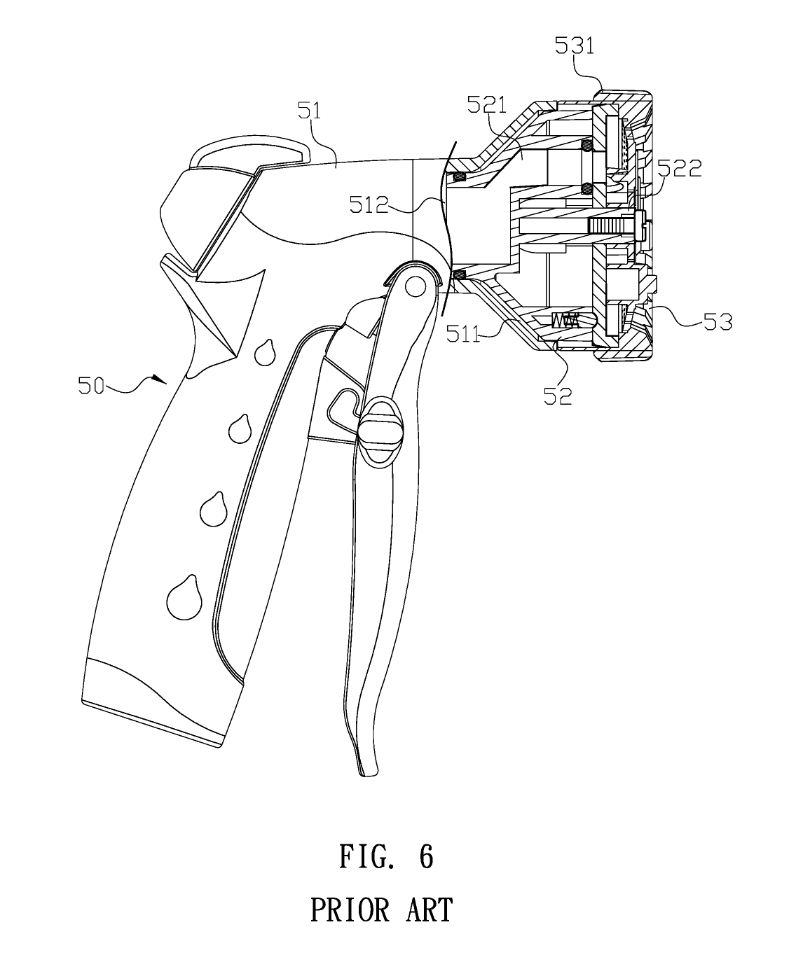

FIG. 7 is a local enlarged view of the conventional structure.

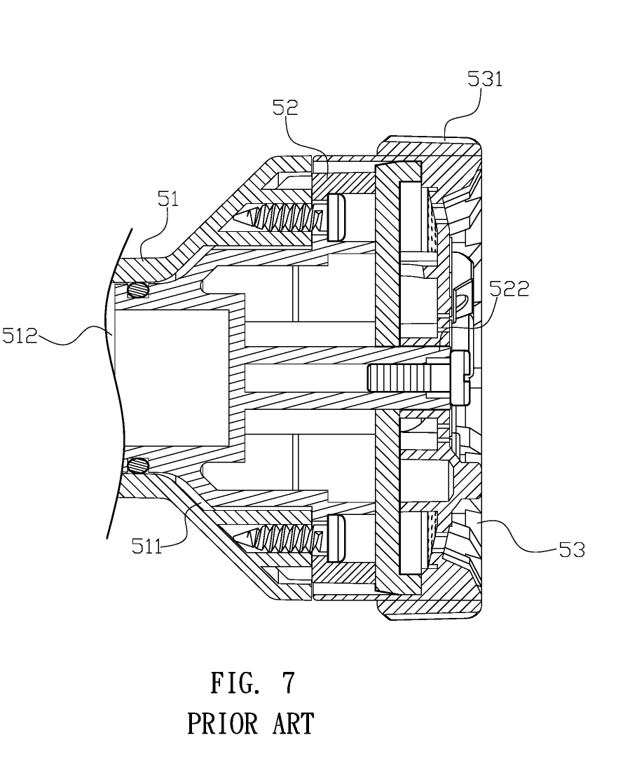

### DETAILED DESCRIPTION OF PREFERRED EMBODIMENT

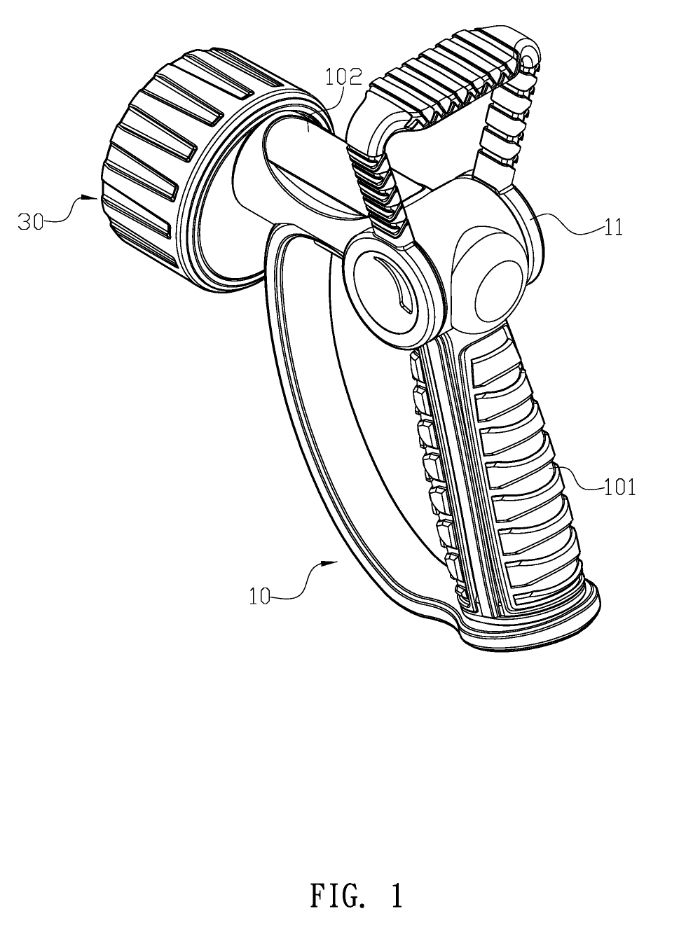

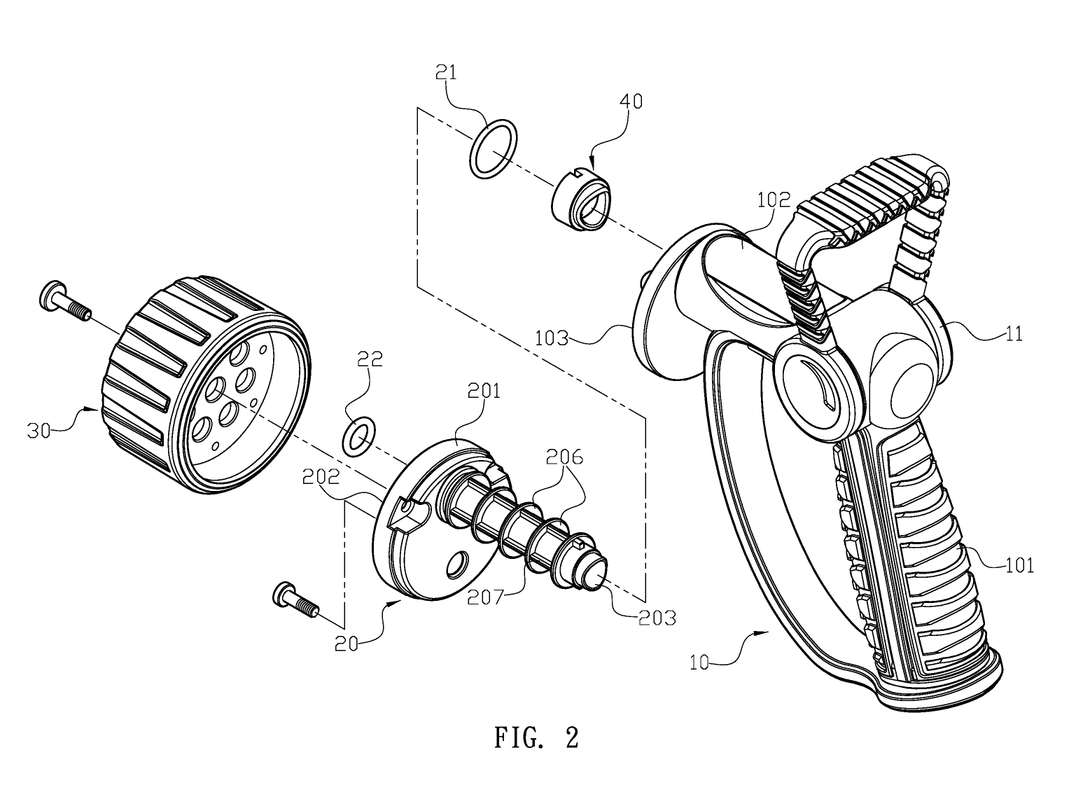

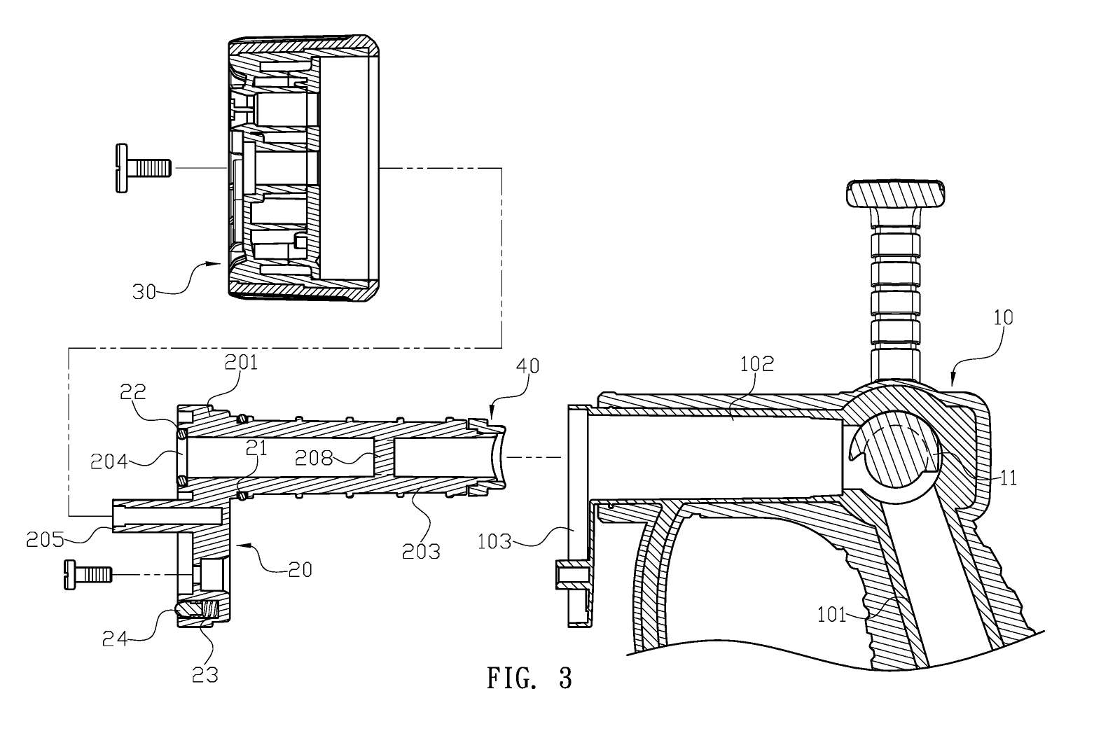

First, please refer to FIG. 1, FIG. 2 and FIG. 3. A Garden spray comprises: a main body 10, a water guiding member 20 and a spray head 30. The main body 10 has a handle portion 101 and a chamber portion 102 which are connected with each other, the handle portion 101 is configured for connecting with a water source and hand-held purpose, and water is fed to from the handle portion 101 to the chamber portion 102 while the handle portion 101 is held. Furthermore, an engagement opening 103 provided in front of the chamber portion 102 is configured for engaging with the water guiding member 20, after a supply tube 203 provided with the water guiding member 20 is inserted the chamber portion 102. The water guiding member 20 is a housing 201 having a front opening 202, and the supply tube 203 protrudes from a closed surface of a rear portion of the housing 201. A front end of the supply tube 203 is defined as an output opening 204 passes through the housing 201 and the supply tube 203 is inserted into the chamber portion 102 through the engagement opening 103 so that the water guiding member 20 can be extensively connected to the main body 10 due to the combination between the chamber portion 102 and the supply tube 203. Moreover, a stopping member 40 is sandwiched between the supply tube 203 and the end portion of the chamber portion 102. Also, the water guiding member 20 is provided with a central shaft 205 extending from the front opening 202, and the central shaft 205 passes through the spray head 30 and the central shaft 205 is locked so that the spray head 30 is mounted at the front of the water guiding member 20. An outer circumference of the supply tube 203 is provided with at least a sealing washer 21, and the output opening 204 is provided with a sealing ring 22.

The engaging opening 103 correspondingly matches the chamber portion 102. The garden sprayer further has a press-control valve 11 disposed between the handle portion 101 and the chamber portion 102 of the main body 10 such that the press-control valve is capable of controlling the water supply of the main body 10. The water guiding member 20 is locked with the main body 10. Moreover, the water guiding member 20 further includes a positioning device comprising a spring 23 and a positioning pin 24. The supply tube 203 further includes a plurality of cross over circular ribs 206 and protruding ribs 207, for enforcing the supply tube 203. The supply tube further includes a cross-shaped divider 208. The stopping member 40 is a hollow stepped sleeve.

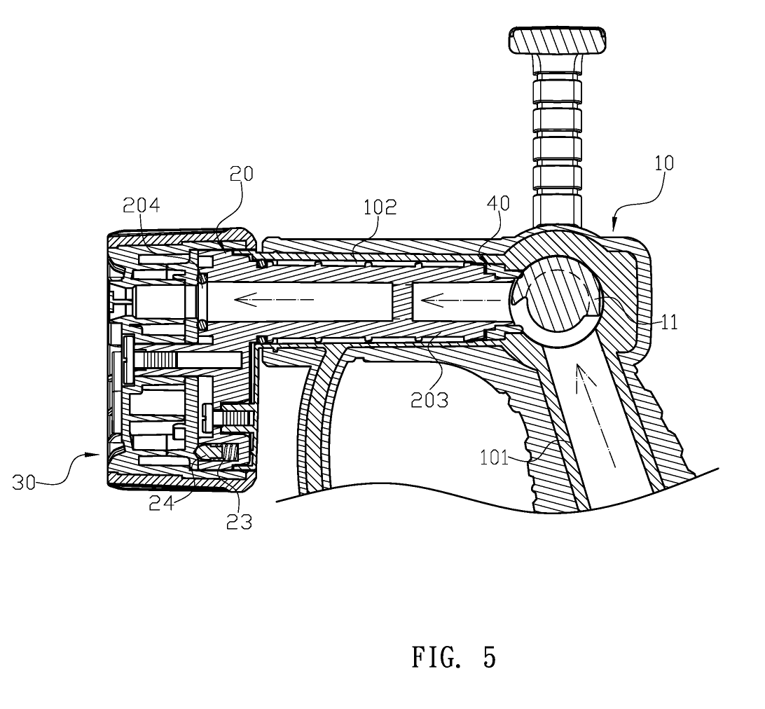

Please refer to FIG. 5. For actual operation, the water flows from the handle portion 101 through the chamber portion 102 into the supply tube 203 and transfers by the output opening 204, and the outer peripheral wall of the spray head 30 provide a grip area for rotation. Therefore, users can choose the appropriate water stream shape. Furthermore, with substantial extension of the supply tube 203, and the chamber portion 102 to do a wide range connection which can avoid easy water leakage. Therefore, the garden spray can be more reliable and can effectively prevent water from always being leaking from the connection of the main body and the water guiding member.

Although the present invention has been explained in relation to its preferred embodiment, it is to be understood that many other possible modifications and variations can be made without departing from the spirit and scope of invention as hereinafter claimed.

What is claimed is:

1. A garden sprayer comprising: a main body, a water guiding member and a spray head, wherein:
the main body having a connecting handle portion and a connecting chamber portion, the handle portion configured for being connected to a water supply and allowing water to flow from the handle portion to the chamber portion; an engaging opening provided at a front end of the chamber portion, a supply tube of the water guiding member inserted into the chamber portion, and the engaging opening being engaged with the water guiding member; and
the water guiding member having a housing with a front opening, a supply tube extending from a rear closed side of the housing, an output opening passing through the housing at a front end of the supply tube, the supply tube inserted into the chamber portion from the engaging opening allowing the water guiding member to use the supply tube to connect to the chamber portion; a stopping member sandwiched between the supply tube and the end of the chamber portion; a central shaft extending from the front opening in the housing of the water guiding member, the central shaft passing through the spray head and locked with the water guiding member by at least one screw, at least one sealing washer jacketed onto the supply tube, and a sealing ring secured onto the output opening.

2. The garden sprayer as claimed in claim 1, wherein the engaging opening correspondingly matches the chamber portion.

3. The garden sprayer as claimed in claim 1, wherein a press-control valve is disposed between the handle portion of the main body and the chamber portion.

4. The garden sprayer as claimed in claim 1, wherein the water guiding member is locked with the main body.

5. The garden sprayer as claimed in claim 1, wherein the water guiding member further includes a positioning device comprising a spring and a positioning pin.

6. The garden sprayer as claimed in claim 1, wherein the supply tube further includes a plurality of cross over circular ribs and protruding ribs.

7. The garden sprayer as claimed in claim 1, wherein the supply tube further includes a cross-shaped divider.

8. The garden sprayer as claimed in claim 1, wherein the stopping member is a hollow stepped sleeve.
